(19) United States
(12) Patent Application Publication
(10) Pub. No.: US 2007/0247124 A1
(43) Pub. Date: Oct. 25, 2007

(54) POWER SUPPLY APPARATUS AND POWER SUPPLY METHOD

(75) Inventor: Tetsuya MIHASHI, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/689,528

(22) Filed: Mar. 22, 2007

(30) Foreign Application Priority Data
Apr. 19, 2006 (JP) 2006-115996

(51) Int. Cl. G05F 1/613

(52) U.S. Cl. 323/224

(57) ABSTRACT

A power supply apparatus and power supply method that are able to decrease the overshoot/undershoot that occurs at the time of power supply voltage switching and enhance the voltage switching speed. Power supply apparatus 100, when in a transient state where output voltage is increased, supplies DAC value DD1 of DCDC register 202, which is the register for switching regulator 400, to LDO DAC 302 in place of DAC value LDO1 of LDO register 201, which is the register for series regulator 300, and LDO DAC 302 of series regulator 300 performs DAC operation while referring to DAC value DD1 of DCDC register 202.

### CROSS REFERENCE TO RELATED APPLICATIONS

The disclosure of Japanese Patent Application No. 2006-115996 filed on Apr. 19, 2006 including the specification, drawings, and abstract is incorporated herein by reference in its entirety.

### BACKGROUND OF THE INVENTION

1. Field of the Invention

The present invention relates to a power supply apparatus and power supply method for supplying stable DC voltage to various electronic devices, and more particularly to a power supply apparatus and power supply method wherein the output voltage is controlled by a digital analogue converter (DAC).

2. Description of Related Art

Along with the performance enhancement of electronic devices in recent years, there has been an increase in the number of cases where a large number of CPUs are arranged on a single substrate. In addition, due to the demand for high-speed arithmetic processing in the CPU unit as well, there has been a trend of increasing CPU current consumption to a greater degree than ever before. As a result, power enhancement and a decrease in the power consumption of the system power supply that supplies power supply voltage to the CPU are critical issues. In particular, for example, a mobile telephone requires extended CPU activation by battery, resulting in a high demand for decreased power consumption. Possible means for developing decreased power consumption include switching between the switching regulator and series regulator as necessary and using them as the power supply circuit. The switching regulator has good power efficiency when CPU operates, but typically the efficiency deteriorates when CPU stands by due to its high power consumption. On the other hand, the series regulator has low power consumption and is therefore ideal as a power supply circuit when CPU stands by. Thus, a mobile device power supply system comprising two regulators, a series regulator and switching regulator, wherein the regulators are switched in accordance with usage conditions has become mainstream (for example, refer to patent document 1: Japanese Patent Application Laid-open No. 2004-88853).

In addition, along with the enhanced performance of the mobile telephone in the last several years, the number of situations in which TV, animation, game display, and other image processing are continually used over a long period of time has increased, making the decrease of power consumption when CPU operates is a critical issue as well. Here, a method for switching the power supply voltage level according to the size of the load when CPU operates has been proposed. The amount of power is lowered by increasing the voltage level when the load is high and conversely decreasing the voltage level when the load is low. However, the risk exists that the voltage required for operation is not be supplied due to the CPU process or the conditions of substrate, resulting in system shutdown. Thus, a slight margin needs be taken with the power supply voltage, resulting in many power consumption reduction restrictions. To avoid this, a system having a voltage detection function on the CPU side and requesting the optimal power supply voltage for operation for the power supply circuit has been devised. The power supply voltage required by the CPU is transmitted via DAC to the power supply circuit and the power supply circuit outputs the power supply voltage in accordance with the request. The voltage detector on the CPU side detects the power supply voltage, determines whether the voltage is compatible or incompatible with the desired voltage level, and feeds back the result to the power supply circuit. This series of feedback control is performed in a certain cycle, thereby optimizing the power supply voltage. Because CPU load conditions constantly fluctuate, further power consumption is possible as the optimization feedback cycle becomes shorter. As a power supply circuit, enhancement of the DAC control based output voltage switching speed is required.

FIG. 1 is a diagram showing the configuration of the prior art power supply apparatus described in patent document 1. FIG. 2 is a timing chart showing the operations of the power supply apparatus of FIG. 1.

In FIG. 1, power supply apparatus 10 is configured with battery 11, inductor 12, capacitor 13, switching regulator IC 14, series regulator 15, and control circuit 16.

Switching regulator IC 14 and inductor 12 constitute switching regulator 17. Switching regulator 17 and series regulator 15 receive voltage Vbat from battery 11, the respective output terminals Vo1 and Vo2 are short circuited by terminal Vo, and the two share output capacitor 13. Neither regulator 15 or 17 is provided with a current sinking capacity and thus the regulator with the higher output voltage setting supplies current to load 20 and the regulator with the lower output voltage setting is in operation stopped state. Both regulators 15 and 17 can set the output voltage by control circuit 16 and can further control the ON/OFF of the operation. FIG. 2 shows the operations of regulators 15 and 17 using a timing chart. When switching regulator 17 and series regulator 15 are simultaneously set to on, the output voltage of switching regulator 17 is surely set to a high value. This is because switching regulator 17 turns on at the time of a heavy load current and thus control is achieved by taking into consideration the operations of switching regulator 17, which has a high power efficiency rate at the time of a heavy load.

Nevertheless, in such a prior art power supply apparatus that switches between switching regulator and series regulator operations, overshoot or undershoot errors occur at the time of power supply voltage switching, and the characteristics at the time of output voltage switching present a problem.

For example, in the voltage switching from interval D to interval E in FIG. 2, output voltage Vo1 of switching regulator 17 decreases from 3V to 2.5V. When the load current is low at this time, the duration until the output voltage of switching regulator 17, which is not provided with a current sink capacity, reaches the required voltage (2.5V) and stabilizes increases significantly. And, in the voltage switching from interval E to interval F in FIG. 2, output voltage Vo1 of switching regulator 17 increases from 2.5V to 3.0V. Although not shown in FIG. 2, significant overshoot seems to occur on the actual output waveform at the time of the above-mentioned power supply switching operation. This is due to the low response speed of output voltage of switching regulator 17. Until the set output voltage is achieved, switching regulator 17 operates at the maximum power capacity, but overshoot occurs during the period after the output voltage exceeds the set value until the power capacity decreases. Furthermore, when the load current is low at this time, switching regulator 17 requires a long period of time until the output voltage set after overshoot stabilizes due to absence of sink capacity.

Though the DAC control based output voltage switching speed needs to be enhanced as described above, the output voltage response speed of the switching regulator is slow. Thus, the feedback loop of the overall system that combines the CPU and power supply circuit becomes unstable, resulting in the risk of system instability. In addition, when the output voltage of the switching regulator is switched, overshoot or undershoot occurs. Because the CPU chip has a low withstand pressure due to process miniaturization, problems such as device breakage due to overshoot or system reset due to undershoot occur. Although the series regulator has a fast response speed and does not result in overshoot or undershoot, the efficiency at the time of a heavy load decreases.

### SUMMARY OF THE INVENTION

It is therefore an object of the present invention to provide a power supply apparatus and power supply method that are able to decrease the overshoot/undershoot that occurs at the time of power supply voltage switching and enhance the voltage switching speed.

According to an aspect of the invention, a power supply apparatus having: a series regulator that generates and outputs output voltage in accordance with an output target voltage; a switching regulator that generates and outputs output voltage in accordance with an output target voltage; and a control apparatus that switches between the series regulator and the switching regulator according to the settings of the output target voltages, wherein: the output of the series regulator and the output of the switching regulator are connected; and the control apparatus, when in a stationary state, sets the output target voltage of the series regulator less than or equal to the output target voltage of the switching regulator and, when the output voltage is changed, sets the output target voltage of the series regulator as the output target voltage of the power supply apparatus for just a predetermined period of time.

According to another aspect of the invention, a power supply apparatus having: a series regulator that controls output target voltage according to output of a first DAC; a switching regulator that controls output target voltage according to output of a second DAC; and a control apparatus that inputs data to the first DAC and the second DAC, wherein: the output of the series regulator and the output of the switching regulator are connected; and the control apparatus, when in a stationary state, sets the output target voltage of the series regulator equal to or less than the output target voltage of the switching regulator and, when the output voltage is changed, sets the output target voltage of the series regulator as the output target voltage of the power supply apparatus for just a predetermined period of time.

According to another aspect of the invention, a power supply method for switching between a series regulator and switching regulator that share an output terminal in accordance with usage conditions and supplying power, wherein: when in a stationary state, output target voltage of the series regulator is set equal to or less than output target voltage of the switching regulator; and when the output voltage is changed, the output target voltage of the switching regulator is set to the output target voltage of the series regulator for just a predetermined period of time so that power is supplied by the series regulator, even if power of the output voltage is to be supplied by the switching regulator.

### BRIEF DESCRIPTION OF THE DRAWINGS

FIG. 1 is a block diagram showing the configuration of a power supply apparatus of prior art;

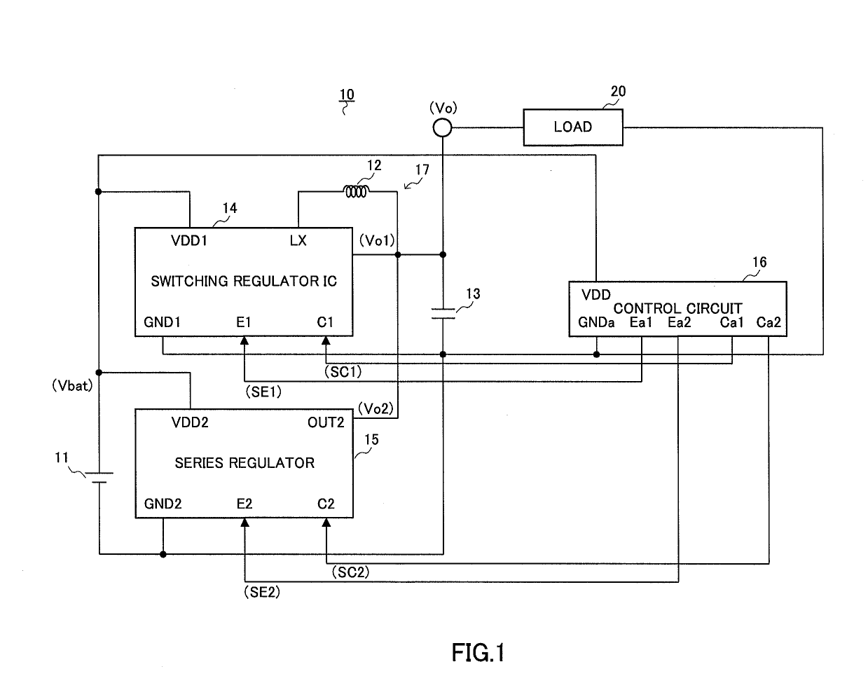

FIG. 2 is a timing chart showing the operations of the power supply apparatus of prior art;

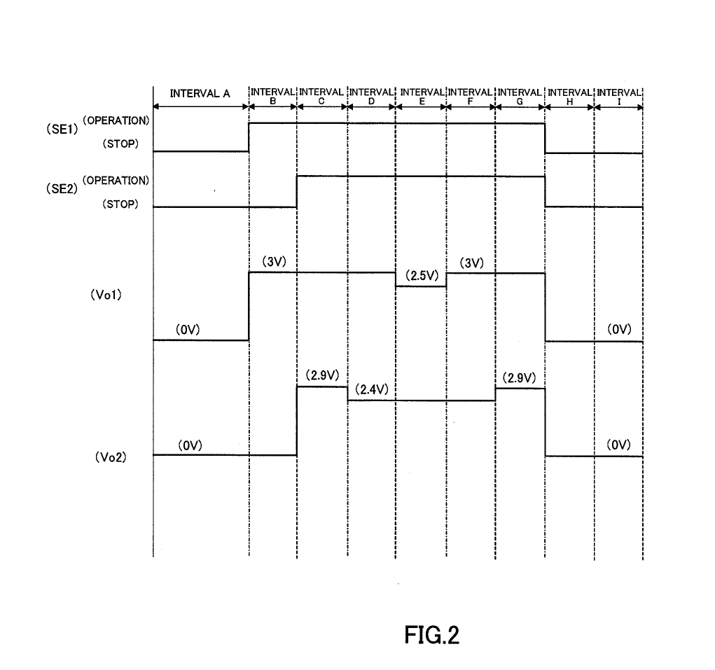

FIG. 3 is a circuit diagram showing the configuration of the power supply apparatus according to Embodiment 1 of the present invention;

FIG. 4 is a circuit diagram describing the operations of the power supply apparatus according to Embodiment 1;

FIG. 5 is a timing chart of output voltage switching showing the operations of the power supply apparatus according to Embodiment 1;

FIG. 6 is a circuit diagram showing the configuration of the power supply apparatus according to Embodiment 2 of the present invention;

FIG. 7 is a circuit diagram describing the operations of the power supply apparatus according to Embodiment 2; and

FIG. 8 is a timing chart of output voltage switching showing the operations of the power supply apparatus according to Embodiment 2.

### DETAILED DESCRIPTION OF THE PREFERRED EMBODIMENT

Now embodiments of the present invention will be described in detail with reference to the accompanying drawings.

### Embodiment 1

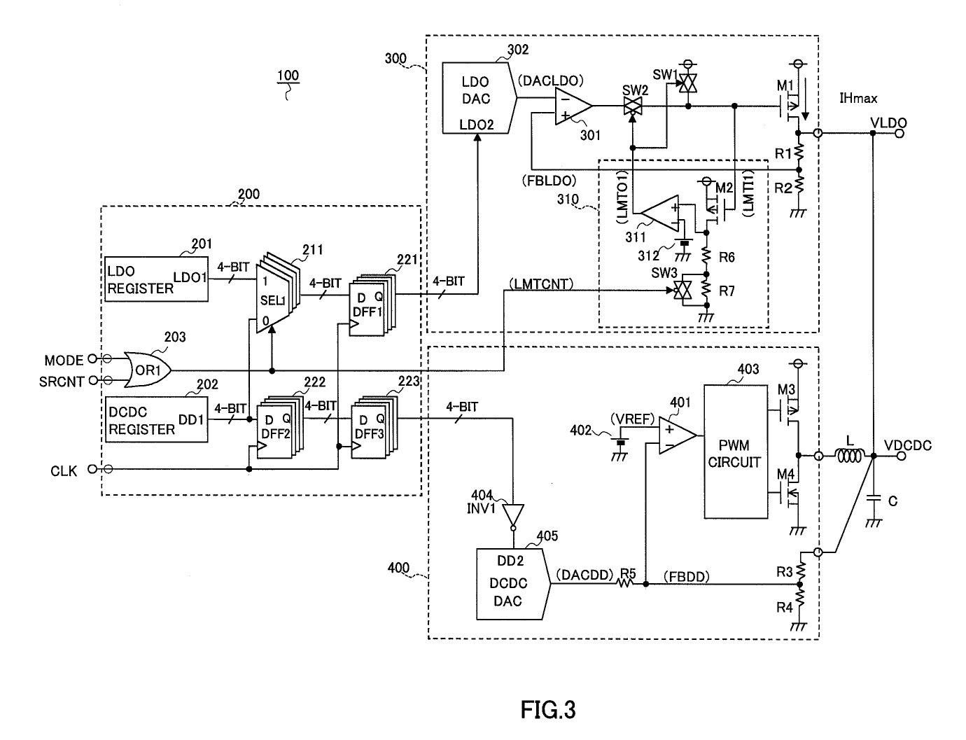

FIG. 3 is a circuit diagram showing the configuration of the power supply apparatus according to Embodiment 1 of the present invention. The present embodiment is an example of application to a power supply apparatus where the output voltage is controlled by a DAC.

In FIG. 3, power supply apparatus 100 is comprised of inductor L, capacitor C, DAC value control apparatus 200 that inputs data to the first DAC and the second DAC, series regulator 300 that controls the output target voltage according to the output of the first DAC, and step-down switching regulator 400 that controls the output target voltage according to the output of the second DAC, wherein output voltage VLDO of series regulator 300 and output voltage VDCDC of switching regulator 400 are connected and share a common output.

DAC value control apparatus 200 is comprised of a first register LDO register 201 that outputs (4-bit) data corresponding to the output target voltage of series regulator 300 when in a stationary state, a second register DCDC register 202 that outputs (4-bit) data corresponding to the output target voltage of switching regulator 400, OR gate circuit 203 (OR1) that outputs to selector 211 and current restriction circuit 310 the OR logic of the MODE signal and SRCNT signal as a control signal, 4-bit selector 211 (SEL1) that selects the output of DCDC register 202 for just a predetermined period of time when in a transient state where output voltage changes, 4-bit D flip-flop 221 (DFF1) that latches and outputs to LDO DAC 302 (first DAC) of series regulator 300 the output of selector 211 with the clock signal CLK input to the clock terminal, 4-bit D flip-flop 222 (DFF2) that latches the output of DCDC register 202 with the clock signal CLK, and 4-bit D flip-flop 223 (DFF3) that latches and outputs to DCDC DAC 405 (second DAC) of switching regulator 400 the output of D flip-flop 222 (DFF2) with the clock signal CLK.

D flip-flops 222 and 223 output to the second DAC the output of DCDC register 202 after a predetermined delay period. Here, D flip-flop 223 synchronizes the timing at which D flip-flop 221 latches and outputs to LDO DAC 302 (first DAC) of series regulator 300 the output of selector 211 (SEL1) and the timing at which D flip-flop 222 outputs to DCDC DAC 405 (second DAC) of switching regulator 400 the output of selector 211 (SEL1).

Series regulator 300 is comprised of output transistor M1, which is a P channel MOS transistor, feedback resistors R1 and R2, error amp 301, LDO DAC 302 (first DAC), current limit circuit 310 that controls the current limit value of output transistor M1, and analog switches SW1 and SW2 that is comprised of transfer gates. Current limit circuit 310 is comprised of current detection MOS transistor M2, detection resistors R6 and R7 that detect the current of current detection MOS transistor M2, overcurrent detection comparator 311 that compares detection voltage that occurs in resistors R6 and R7 connected in series, to a predetermined value, reference voltage source 312 that produces a reference voltage, and analog switch SW3 that receives a control signal (LMTCNT) from OR gate circuit 203 and causes a short circuit in resistor R7. Current limit circuit 310 shuts down output transistor M1 when overcurrent flows to output transistor M1. In addition, current limit circuit 310 performs current limit control that increases the current limit value of output transistor M1 at the time of output voltage switching.

Switching regulator 400 is comprised of output drive MOS transistor M3, rectification MOS transistor M4, inductor L, feedback resistors R3 and R4, error amp 401, reference voltage source 402 that produces a reference voltage (VREF), PWM circuit 403, inverter 404 (INV1), DCDC DAC 405 (second DAC), and resistor R5. Although the present embodiment employs a PWM circuit as the typical control circuit as an example, any type of control circuit may be used. In addition, the current mode method rather than the voltage control method may be applied as well.

The above series regulator 300 and switching regulator 400 control the output voltages VLDO and VDCDC according to the respective signals LDO2 and DD2 from DAC value control apparatus 200. When in a stationary state, the output target voltage of series regulator 300 is set to the output target voltage of switching regulator 400 or less; and, when the output voltage is changed, the output target voltage of series regulator 300 is set as the output target voltage of power supply apparatus 100 for just a predetermined period of time. According to the detailed operations described hereafter, a side-by-side configuration where the operation switches according to the whether the load is heavy or light is adopted.

Now, the operations of the power supply apparatus configured as mentioned above will be described.

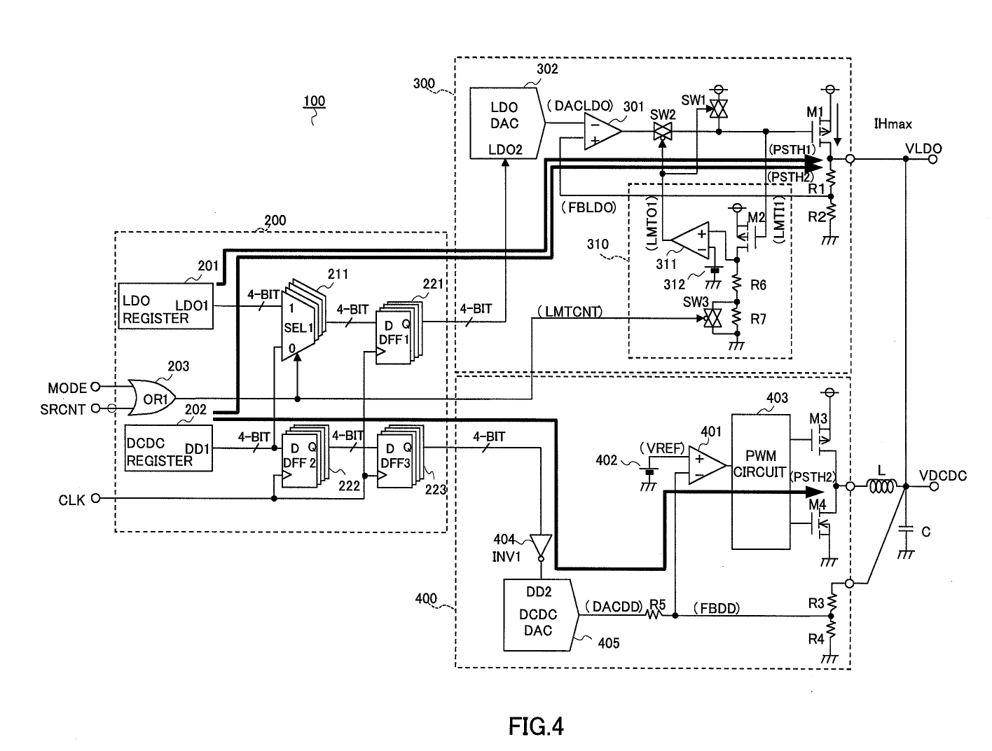

FIG. 4 is a circuit diagram describing the operations of power supply apparatus 100 of FIG. 3. The bold arrow in FIG. 4 shows the flow (path 1) to (path 3) of the operations of series regulator 300 and switching regulator 400 between which operation is switched according to whether the load is heavy or light.

First, the basic operations of series regulator 300 will be described.

To the source of output transistor M1 of series regulator 300, power supply voltage is applied and the output voltage VLDO of series regulator 300 is output from the drain. Output voltage VLDO is detected by feedback resistors (R1 and R2) and input to error amp 301 as the detected voltage (FBLDO).

LDO DAC 302 outputs voltage DACLDO that changes in accordance with the DAC value (LDO2) input from D flip-flop 221 (DFF1) of DAC value control apparatus 200, using the voltage of the internal reference voltage source (not shown) as the reference voltage. Output voltage DACLDO of LDO DAC 302 is input to error amp 301, and error amp 301 amplifies and outputs the error voltage between output voltage DACLDO of LDO DAC 302 and the detected voltage (FBLDO) to the gate of output transistor M1 via analog switch SW2. That is, output transistor M1 is controlled so that the detected voltage (FBLDO) of output voltage VLDO becomes equal to output voltage DACLDO of LDO DAC 302. Output voltage VLDO of series regulator 300 is in proportion to the DACLDO voltage and is expressed by equation (1):

VLDO=DACLDO×(1+R1/R2) (1)

Series regulator 300 is used for light loads and thus cases exist where the load current at the time of output voltage switching exceeds the current limit value of series regulator 300, making increase of the output voltage no longer possible. In this case, as will now be described, the current limit value is raised at the time of output voltage switching only. Current detection MOS transistor M2 of current limit circuit 310 is a current detection MOS transistor of output transistor M1, and the gate is connected to the gate (LMTI1) of output transistor M1, and constitutes a current mirror together with output transistor M1. The drain of current detection MOS transistor M2 is connected to detection resistor R6. When the drain current of output transistor M1 increases, the drain current (Ids2) of current detection MOS transistor M2 also increases proportionately, causing the output level (LMTO1) of overcurrent detection comparator 311 to switch from L to H when Ids2×(R6+R7) exceeds a predetermined value. At this time, switch SW2 turns off, switch SW1 turns on, and the gate of output transistor M1 is pulled up to the power supply voltage, thereby turning off output transistor M1 and thus setting the current limit. To raise the current limit value (IHmax), switch SW3 that is in parallel with resistor R7 turns on. When switch SW3 turns on, the values of the detection resistors (R6+R7) lower to (R6), thereby increasing the current limit value (IHmax).

Next, the basic operations of switching regulator 400 will be described.

Switching regulator 400, using inductor L and output capacitor C, smoothes the pulse voltage generated by PWM circuit 403 alternately turning on and off output drive transistor M3 and rectification transistor M4, thereby supplying output voltage VDCDC to the load. Output VDCDC of switching regulator 400 is connected to output VLDO of series regulator 300 and is detected by feedback resistors R3 and R4. This detected voltage (FBDD) is input to error amp 401.

DCDC DAC 405 outputs voltage (DACDD) that changes in accordance with the DAC value (DD2) input from D flip-flop 223 (DFF2) of DAC value control apparatus 200, using the voltage of the internal reference voltage source (not shown) as the reference voltage. The output voltage (DACDD) of DCDC DAC 405 is applied to the connection points of feedback resistors R3 and R4 via resistor R5, and input to error amp 401. Error amp 401 amplifies and outputs the error voltage between the reference voltage (VREF) and the detected voltage (FBDD) of reference voltage source 402 to PWM circuit 403. PWM circuit 403 alternately turns off and on output drive transistor M3 and rectification transistor M4 based on an on/off time ratio corresponding to the error voltage. That is, the on/off time ratio between output drive transistor M3 and rectification transistor M4 is adjusted so that the reference voltage (VREF) and detected voltage (FBDD) of reference voltage source 402 become equal.

For example, when the reference voltage (VREF) of reference voltage source 402 is input to the positive input of error amp 401 and the attenuator voltage of feedback resistors R3 and R4 is input to the negative input of error amp 401, and error amp 401 monitors the attenuator voltage. When output voltage VDCDC decreases, the output of error amp 401 bounces up and PWM circuit 403 switches output drive transistor M3 and rectification transistor M4 in accordance with error amp 401, and, in this case, increases output voltage VDCDC by lengthening the “on” time of output drive transistor M3 with respect to the “on” time of rectification transistor M4.

Output voltage VDCDC of switching regulator 400 is expressed by equation (2) using the output voltage of DCDC DAC 405 (DACDD), resistance of feedback resistors (R3, R4), reference voltage (VREF) output by reference voltage source 402, and resistance of resistor R5 between the output of DCDC DAC 405 and the negative input of error amp 401.

VDCDC=VREF×(1+R3/R4)−(DACDD−VREF)×R3/R5 (2)

By setting the DACDD voltage as shown in the above equation (2), the output voltage of switching regulator 400 can be controlled. The VDCDC voltage from the above equation (2) monotonically decreases with respect to increase of the DACDD voltage. This is the inverse of the relationship between the output voltage VLDO and DAC voltage and in the case of series regulator 300. Thus, the signal that inverts the output of DAC value control apparatus 200 in inverter 404 (INV1) is input to DCDC DAC 403 as signal DD2.

Next, the operations of DAC value control apparatus 200 will be described.

In DAC value control apparatus 200, LDO register 201 is a series regulator register and DCDC register 202 is a switching regulator register. The basic concept of the present embodiment includes, at startup, DAC value DD1 of DCDC register 202, which is the register for switching regulator 400, is replaced with DAC value LD01 of LDO register 201, which is the register for series regulator 300, and the result is supplied to LDO DAC 302 (first DAC). At startup, LDO DAC 302 (first DAC) of series regulator 300 operates DAC while referring to DAC value DD1 of DCDC register 202, which is the register for switching regulator 400. This is the flow of (path 2). The MODE signal and SRCNT signal are the control signals for this, and selector 211 (SEL1) is the selection circuit for this.

The input signal MODE is a mode switching signal, and, when MODE=L, both switching regulator 400 and series regulator 300 operate in “switching regulator mode,” and, when MODE=H, switching regulator 400 stops and only series regulator 300 operates in “series regulator mode”. The characteristic of the present embodiment lies in “switching regulator mode” and thus only “switching regulator mode” will be described. For this reason, the MODE signal is always L.

The input signal SRCNT is H when the output voltage is constant and L when the output voltage is switched.

When SRCNT=H, input “1” of selector 211 (SEL1) in FIG. 4 is selected, thereby enabling (path 1) and causing VLDO to output DAC value LDO1 of LDO register 201, which is the series regulator register. Conversely, when SRCNT=L, input “0” of selector 211 (SEL1) is selected, thereby shutting down (path 1) and enabling (path 2), and VLDO outputs DAC value DD1 of DCDC register 202, which is the switching regulator register.

On the other hand, VDCDC outputs only DAC value DD1 of DCDC register 202 in (path 3). The output data of the registers 201 and 202 is latched in D flip-flops 221 to 223 (DFF1 to DFF3) constituting a latch circuit, so that the data switches at the rising edge of the clock signal CLK. DFF2 and DFF3 form a shift register and (path 3) switches the data after a one clock delay compared to (path 1) and (path 2).

In addition, the input signals MODE and SRCNT are input to OR gate circuit 203 (OR1), and OR gate circuit 203 outputs signal LMTCNT. The signal LMTCNT is input to selector 211 (SEL1) and selector 211 (SEL1) selects, as the input data of D flip-flop 221 (DFF1), output LDO1 of LDO register 201 when LMTCNT=H or output DD1 of DCDC register 202 when LMTCNT=L. Furthermore, signal LMTCNT activates switch SW3 of current limit circuit 310 of series regulator 300. SW3 turns off when LMTCNT=H, and SW3 turns on and causes a short circuit in resistor R7 when LMTCNT=L.

Here, in switching regulator 400, inverter 404 (INV1) inputs the inverted DAC value DD1 as DD2 to DCDC DAC 405 to establish a relationship where output voltage VDCDC monotonically increases with respect to the increase of DAC value DD1 of LDO register 201.

Next, the output voltage switching method will be described.

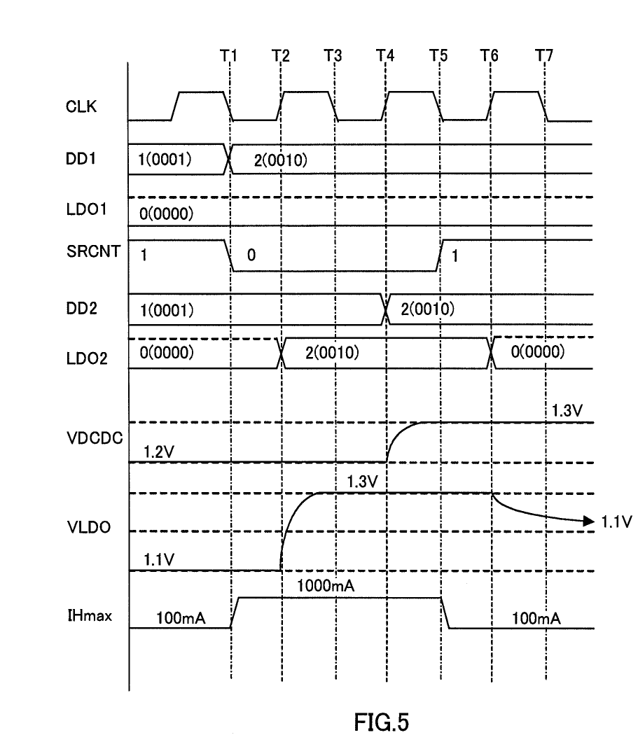

FIG. 5 is a timing chart of output voltage switching showing the operations of power supply apparatus 100. The numerical values in parentheses for DD1, DD2, LDO1, and LDO2 of FIG. 5 indicate the 4-bit values of the respective data.

In regulators 300 and 400, the output voltages 1.1, 1.2, and 1.3V are output when the DAC value is 0, 1, and 2, respectively. Because the outputs of series regulator 300 and switching regulator 400 are connected, the output voltage of power supply apparatus 100 is the higher of the two values VLDO and VDCDC. In FIG. 5 and in the following descriptions, VLDO indicates the output target voltage of series regulator 300 and VDCDC indicates the output target voltage of switching regulator 400. In addition, when MODE=H, power supply apparatus 100 mainly uses switching regulator 400. Therefore, assume that, when the output voltage is changed, DAC value DD1 of register 102 changes 1 or 2 and DAC value LDO1 of LDO register 201 is fixed to “0.”

In addition, the current limit value (IHmax) is 100 mA when LMTCNT is H, and to 1000 mA when LMTCNT is L (during output voltage switching).

In the initial state, input signal SRCNT is H. Therefore, (path 1) and (path 3) are valid, and the output target voltage VLDO of series regulator 300 is 1.1V and output target voltage VDCDC of switching regulator 400 is 1.2V. Power supply apparatus 100 operates giving priority to switching regulator 400, and the output voltage is set to VDCDC=1.2V.

At time T1, DAC value DD1 switches from 1 to 2 and input signal SRCNT switches from H to L. (Path 1) becomes invalid and (path 2) becomes valid, and series regulator 300 is ready for outputting switching regulator DAC value DD1. Although (path 2) becomes valid, DAC value DD1 of DCDC regulator 202 is actually delivered to LDO DAC 302 (first DAC) of series regulator 300 at time T2, i.e., at the start of the rising edge of the clock of D flip-flop 221 (DFF1). In addition, at time T2, LDO2 switches from “0” to “2.” This is the state in which the output of D flip-flop 221 (DFF1) latches the value of “2” of switching regulator 400 from the initial value of “0” of series regulator 300. In addition, because SRCNT changes to L, signal LMTCNT also changes to L, thereby switching the current limit value (IHmax) of series regulator 300 from 100 mA to 1000 mA.

After DD1 is switched, the first CLK rising edge starts at time T2 and switching regulator DAC value DD1=2 is input to LDO2. On the other hand, switching regulator 400 is comprised of D flip-flops 221 and 222 (DFF2 and DFF3) which operate as shift registers, and thus, at time T2, the previous DAC value DD1=1 remains input to DD2 and feedback is controlled so that the output voltage changes to 1.2V. As a result, the output voltage is raised from 1.1V to 1.3V by series regulator 300.

However, in this state, LDO DAC 302 (first DAC) of series regulator 300 operates using LDO, and thus the voltage of LDO is dropped at time T6, which is two clocks after time T2. Specifically, SRCNT changes to H at time T5. As a result, selector 211 (SEL1) switches from the current input “0” to input “1”, introducing the initial value “0” of output LDO1 of LDO register 201 to the input of D flip-flop 221 (DFF1) and subsequently switching LDO2 of LDO DAC 302 (first DAC) of series regulator 300 from 2 to 0 at the rising edge of the clock of time T6.

In this manner, SRCNT changes from L to H, (path 2) becomes invalid, and (path 1) becomes valid at time T5.

Thus, series regulator DAC value LDO2 operates in such a manner that the original LD1=0 value is input and the voltage is changed to 1.1V. In addition, because LMTCNT changes to H, the current limit value (IHmax) also changes to the original value of 100 mA.

Focusing on the operations of switching regulator 400 during the above-described operation of series regulator 300, the rising edge of the second CLK starts after DD1 switching at time T4 before clock 1 that changes SRCNT to H at time T5. At this time, feedback is controlled so that switching regulator DAC value DD2 switches from 1 to 2 and VDCDC outputs 1.3V via (path 3).

As described in the timing chart of FIG. 5, when power supply apparatus 100 switches the output voltage from a 1.2V heavy load (that is, when switching regulator 400 operates) to 1.3V, series regulator 300 responds one clock cycle faster and, based on this fast response performance, pulls up the output voltage to 1.3V without generating overshoot. Switching regulator 400 sets the output target voltage to 1.3V and then forereaches, and, at the next clock, series regulator 300 drops the output target voltage to 1.2V and returns main output back to the highly efficient switching regulator 400.

### This series of operations enables quick voltage switching without overshoot.

As described above, according to the present embodiment, power supply apparatus 100 is comprised of series regulator 300 and switching regulator 400 that share an output terminal; DAC value control apparatus 200 comprises LDO register 201 that sets DAC value LDO1 of LDO DAC 302 to rewritable, DCDC register 202 that sets DAC value DD1 of DCDC DAC 405 to rewritable, selector 211 (SEL1) that selects the output of LDO register 201 when in a stationary state and the output of DCDC register 202 for just a predetermined period of time when in a transient state where output voltage changes, D flip-flop 221 (DFF1) that latches and outputs the output of selector 211 (SEL1) to LDO DAC 302 of series register 300, D flip-flop 222 (DFF2) that latches the output of DCDC register 202, and D flip-flop 223 (DFF3) that latches and outputs to DCDC DAC 405 of switching regulator 400 the output of D flip-flop 222 (DFF2), DAC control apparatus 200 supplying DAC value LDO1 of LDO register 201, which is the register for series regulator 300, in place of the DAC value DD1 of DCDC register 202, which is the register for switching regulator 400, to LDO DAC 302 when in a transient state where output voltage is increased; and LDO DAC 302 of series register 300 operating DAC while referring to DAC value DD1 of DCDC register 202, thereby enabling power supply in accordance with the output target voltage of switching regulator 400 by series regulator 300, which has a fast response speed, for just a predetermined period of time, even when the output voltage ought to be used to supply power from switching regulator 400, and thus achieving voltage switching without overshoot. As a result, device brokerage caused by overshoot in a CPU chip with low withstand pressure is effectively prevented. In addition, because power is quickly supplied by series regulator 300, a stabilizing effect on the feedback loop of the overall system that combines the power supply apparatus with a CPU that receives power supply from the power supply apparatus can be expected.

The above-mentioned effect will now be described in further detail. Regulators 300 and 400 are without current drawing capacity and are designed so that the setting voltage of series regulator 300 changes to a value lower than the setting voltage of switching regulator 400 at the time of a heavy load so that switching regulator 400 operates in a stationary manner. This is shown in FIG. 5 where out put voltage VLDO (1.1V) of series regulator 300 is set to a lower value than output voltage VDCDC (1.2V) of switching regulator 400.

In addition, the outputs of registers 201 and 202 of regulators 300 and 400 have D flip-flop 221 (DFF1) to D flip to flop 223 (DFF3) which hold data, and the DAC value is switched based on the timing of CLK.

When the output voltage of switching regulator 400 is increased, selector 211 (SEL1) is switched so that the DAC value of DCDC DAC 405 (second DAC) of switching regulator 400 retains its original state and the DAC value of LDO DAC 302 (first DAC) of series regulator 300 changes to the register value of DCDC DAC 405 (second DAC) of switching regulator 400 rather than the register value of LDO register 201. As indicated by times T1 to T7 in FIG. 5, based on the timing of CLK, the DAC value of series regulator 300 switches to the target DAC value, and series regulator 300 increases the output voltage. Based on the next CLK timing, the DAC value of switching regulator 400 switches to the target value. Subsequently, selector 211 (SEL1) is switched to change the DAC value of series regulator 300 back to the original DAC value, thereby restoring stationary operation mode where the output voltage setting of switching regulator 400 is higher than the output voltage setting of series regulator 300.

Specifically, in the operations mode of switching regulator 400, DAC value LDO1 of series regulator 300 is set lower than DAC value DD1 of switching regulator 400.

For example, given an initial state where LDO1=0 and DD1=1, immediately after DD1 switches from 1 to 2, the DAC value of switching regulator 400 maintains its original state, and instead, only the DAC value of series regulator 300 switches from LDO1=1 to LDO1=2. In this manner, immediately after the output voltage is switched, regulation is performed using series regulator 300, which has good response and high efficiency at the time of a light load, rather than switching regulator 400 that uses inductor L, so that overshoot does not occur. After that, the DAC value of switching regulator 400 switches from 1 to 2, and then LDO changes back to its original DAC value LDO1=0.

Here, in the prior art example as well, a measure for preventing overcurrent can be employed if a rush current prevention circuit is incorporated in the switching regulator. However, the delay in the operation response of the switching regulator in this case as well cannot be eliminated, and it is difficult to quickly switch the output voltage if an attempt is made to suppress rush current using the rush current prevention circuit. In response, power supply apparatus 100 of the present embodiment prevents the occurrence of rush current and overshoot even during high-speed output voltage switching by first activating the series regulator at the time of output voltage switching.

### Embodiment 2

Although Embodiment 1 provides a method for switching from a low output voltage to a high output voltage, conversely switching from a high output voltage to a low output voltage is difficult. This is because both the series regulator and switching regulator are not provided with a current sink capacity and thus cannot quickly discharge charge stored in the output capacitor. In the prior art example, the voltage switching speed did not need to be increased very much.

In the case where the regulators are provided with a sink capacity, greater disadvantages result, including an increase in chip area due to an increase in elements and increased loss caused by forced discharge of charge once it has been charged to the output capacitor. However, in a system that requires optimum power supply voltage in the power supply circuit from the CPU as described above, the voltage switching speed becomes more critical than the loss caused by the discharge of the capacitor charge.

Embodiment 2 is an example of a power supply apparatus with enhanced voltage switching speed to low voltage.

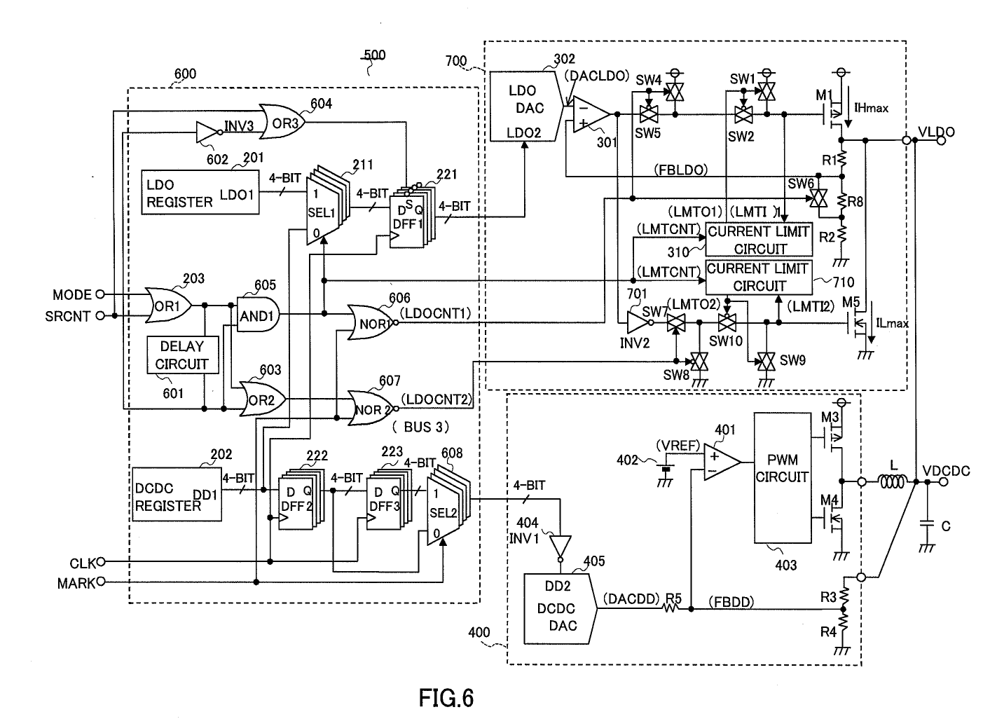

FIG. 6 is a circuit diagram showing the configuration of the power supply apparatus according to Embodiment 2 of the present invention. Components that are the same in FIG. 3 are given the same codes, and duplicate descriptions thereof will be omitted.

In FIG. 6, power supply apparatus 500 is comprised of inductor L, capacitor C, DAC value control apparatus 600 that inputs data to LDO DAC 302 (first DAC) and DCDC DAC 405 (second DAC), series regulator 700 that controls the output target voltage according to the output of LDO DAC 302 (first DAC), and step-down switching regulator 400 that controls the output target voltage according to the output of DCDC DAC 405 (second DAC), wherein output voltage VLDO of series regulator 700 and output voltage VDCDC of switching regulator 400 are connected and share a common output.

DAC value control apparatus 600 is, in addition to the configuration of DAC value control apparatus 200 of FIG. 3, further comprised of delay circuit 601, inverter 602 (INV3) that inverts the MODE signal, OR gate circuit 603 (OR2) that takes the OR logic of the MODE signal and the signal that delayed the output of OR gate circuit 203 (OR1) by delay circuit 601, OR gate circuit 604 (OR3) that outputs to the set terminal of D flip-flop 221 (DFF1) the OR logic of the inverted MODE signal and the SRCNT signal, AND gate circuit 605 (AND1) that takes the AND logic of the MODE signal and the output of OR gate circuit 203 (OR1), NOR gate circuit 606 (NOR1) that takes the NOR logic of the MARK signal and the output of AND gate circuit 605 (AND1), NOR gate circuit 607 (NOR2) that takes the NOR logic of the MARK signal and the output of OR gate circuit 603 (OR2), and 4-bit selector 608 (SEL2) that selects the output of D flip-flop 223 (DFF3) and the output of D flip-flop 222 (DFF2) according to the MARK signal.

Series regulator 700 is, in addition to the configuration of series regulator 300 of FIG. 3, further comprised of sink MOS transistor M5, inverter 701 (INV2), current limit circuit 710 that controls the current limit value of sink MOS transistor M5, and analog switches SW4 to SW10 configured with transfer gates.

Current limit circuit 710 limits the current of sink MOS transistor M5 in the same manner as the above-mentioned current limit circuit 310 controls the current limit value of output transistor M1, and shuts down sink MOS transistor M5 when overcurrent flows to sink MOS transistor M5.

In this manner, series regulator 700 has a configuration with sink MOS transistor M5 and current limit circuit 710 added to source MOS transistor M1.

### In addition, DAC value control apparatus 600 has a configuration with elements such as a gate circuit added for controlling sink MOS transistor M5.

Now, the operations of the power supply apparatus configured as mentioned above will be described.

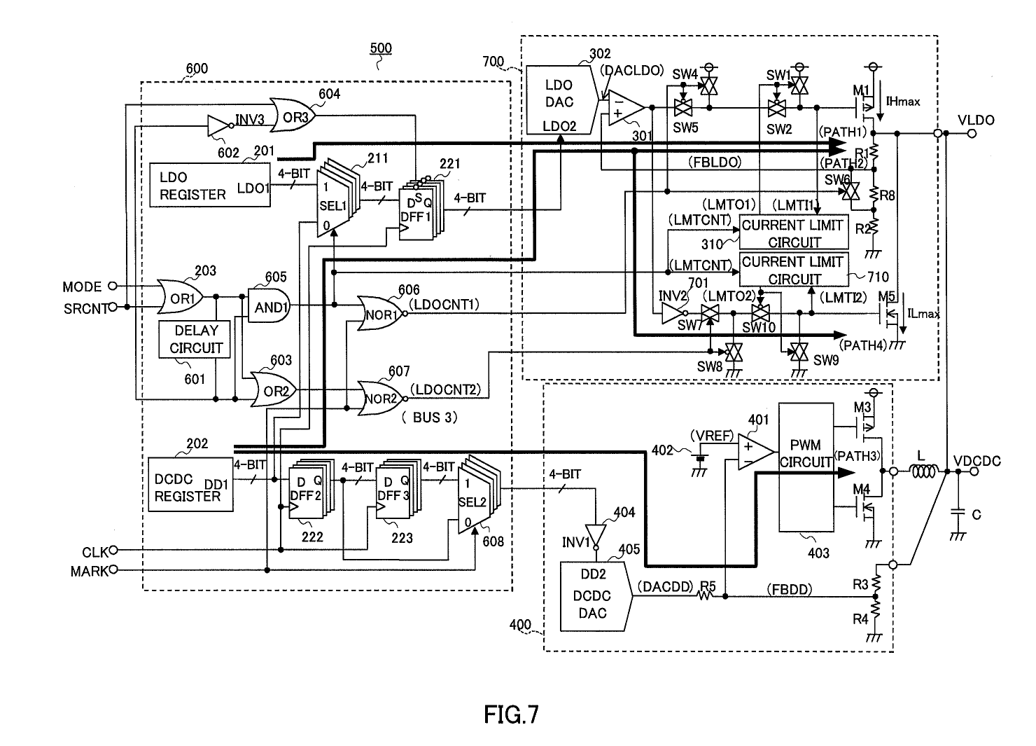

FIG. 7 is a circuit diagram explaining the operations of power supply apparatus 500 of FIG. 6.

### The bold arrow in FIG. 7 shows the flow (path 1) to (path 4) of the operations of series regulator 700 and switching regulator 400 between which operation is switched according to whether the load is heavy or light.

First, the basic operations of series regulator 700 will be described. The basic operations of series regulator 700 are the same as is series regulator 300 of FIG. 3, and their descriptions will be omitted.

Series regulator 700 has sink MOS transistor M5 in addition to source MOS transistor M1. The outputs of error amp 301 include one that is connected to the gate of output transistor M1 via switch SW2 and switch SW5, and another that is connected to the gate of sink MOS transistor M5 via inverter 701 (INV2), which is used for polarity inversion, switch SW7, and switch SW10. With regard to switches SW5 and SW7, because the input gate has inversed polarity, when the same signal is input, the output of error amp 301 is connected to either output transistor M1 or sink MOS transistor M5. In addition, the gate of the transistor to which the output of error amp 301 is not connected is pulled up to power supply voltage and fixed, and pulled down to GND and fixed by switches SW4 and SW8, respectively.

Current limit circuits 310 and 710 perform the operations described below. Current limit circuit 310 is the same as series regulator 300 of FIG. 3, and the output signal LMTO1 switches from level L to level H when the gate voltage (LMTI1) of output transistor M1 exceeds the current limit value (IHmax) of output transistor M1 as it changes in accordance with the size of the drain current of output transistor M1. At this time, switch SW1 turns on and switch SW2 turns off, and output transistor M1 turns off. The current limit value of output transistor M1 switches by LMTCNT.

Current limit circuit 710 monitors the gate voltage of sink MOS transistor M5, performs I-V conversion of the current of the current mirror controlled by the gate voltage of sink MOS transistor M5, and detects the voltage.

When the drain current of sink MOS transistor M5 exceeds a predetermined value, switch SW10 turns off and switch SW9 turns on, and sink MOS transistor M5 shuts down. In this manner, the drain current of sink MOS transistor M5 is detected at the gate voltage (LMTI2) and the output signal (LMTO2) switches from level L to level H when the current limit value is exceeded. At this time, switch SW9 turns on and switch SW1 turns off, and sink MOS transistor M5 turns off.

In addition, on the side of error amp 301 of switch SW9 and switch SW10, switch SW7 and switch SW10 are provided via inverter 701 (INV2) and turns on and off according to the MARK signal input to NOR gate circuit 607 (NOR2). When the register value of DCDC register 202 decreases (when output voltage VLDO decreases), the MARK signal changes to L, the output of NOR gate circuit 607 (NOR2) changes to H, switch SW7 turns on, and switch SW8 turns off. As a result, the output of error amp 301 is connected to the gate of sink MOS transistor M5, and operates so as to allow sink MOS transistor M5 to be valid, i.e. sink capacity is provided. In addition, likewise, on the output transistor M1 side, the error amp 301 side of switch SW1 and switch SW2 is provided with switch SW4 and SW5 which turn on and off by the MARK signal input to NOR gate circuit 606 (NOR1). As a result, the output of error amp 301 is connected to either output transistor M1 or sink MOS transistor M5, and one of output transistor M1 or sink MOS transistor M5 is valid and the other is invalid.

Now the functions of resistor R8 inserted between feedback resistors R1 and R2 of output transistor M1 and the function of switch SW6 which bypasses resistor R8 will be described. When output voltage VLDO of series regulator 700 decreases to an excessive degree, specifically when output voltage VLDO becomes lower than the feedback voltage of DCDC DAC 405 of switching regulator 400, DCDC DAC 405 supplies current for the output in an attempt to raise the output voltage. On the other hand, series regulator 700 operates so as to introduce current at sink MOS transistor M5 in an attempt to further decrease the output voltage. As a result, a local maximum current flows at that moment from output drive MOS transistor M3 of switching regulator 400 through sink MOS transistor M5 via inductor L. To avoid this, the feedback voltage of LDO DAC 302 of series regulator 700 needs to be provided at a higher value than the feedback voltage of DCDC DAC 405 of switching regulator 400. Here, switch SW6 is provided for controlling the output voltage of series regulator 700 so that it increases when sink MOS transistor M5 is valid. When the MARK signal is H, the output signal of NOR gate circuit 606 (NOR1) changes to L and switch SW6 turns off. Because feedback resistors R1 and R2 and resistor R8 are connected in series, the feedback voltage of LDO DAC 302 of series regulator 700 decreases. When the MARK signal is L, the feedback voltage increases, conversely.

The state in which the output of error amp 301 is connected to output transistor M1 is referred to as “source mode” (normal mode), and the state in which the output of error amp 301 is connected to sink MOS transistor M5 is referred to “sink mode”. In addition, the state in which neither is connected is referred to as “open mode”. In “source mode”, (path 1) and (path 2) are valid. In “sink mode”, (path 4) is valid. In “sink mode”, the output voltage always reflects switching regulator DAC value DD1 rather than series regulator DAC value LDO1. However, because the feedback resistance ratio changes by setting switch SW6 to on, the value is set higher than the output voltage of switching regulator 400 by just ΔVLDO=DACLDO×R1×R8/(R8+R2)/R2. ΔVLDO is determined by the output voltage variance of the series regulator, and the relationship VLDO−ΔVLDO>VDCDC is established at all times.

Next, the operations of DAC value control apparatus 600 will be described.

DAC value control apparatus 600 is the DAC value control apparatus of series regulator 700 and switching regulator 400. When selector 608 (SEL2) is inserted in the output of D flip-flop 222 and D flip-flop 223 (DFF2 and DFF3) as the latch circuits, the output of selector 608 (SEL2) is latched to D flip-flop 223 (DFF3) when the signal MARK=H and, to D flip-flop 222 (DFF2) when MARK=L, and selector 608 (SEL2) selects the latch output of either D flip flop 222 or 223.

With delay circuit 601, when input signal SRCNT switches from H to L, the output signal of AND gate circuit 605 (AND1) immediately switches from H to L, and the output signal of OR gate circuit 203 (OR1) switches from H to L after a delay of just the delay time set at delay circuit 601.

When input signal SRCNT switches from L to H, the output of AND gate circuit 605 (AND1) switches from L to H after a delay of just the above-mentioned delay time, and the output of OR gate circuit 203 (OR1) immediately switches from L to H. When the input signal MARK is L, the output signal (LDOCNT1) of NOR gate circuit 606 (NOR1) changes to the output inverted signal of AND gate circuit 605 (AND1) and the output signal of NOR2 (LDOCNT2) changes to the output inverted signal of OR gate 603 (OR2). When the input signal MARK is H, signal LDOCNT1 and signal LDOCNT2 are fixed to L. In addition, the output of OR gate circuit 604 (OR3) is connected to the set terminal of DFF1, switches from H to L when the input signal SRCNT switches from H to L, after that, switches from L to H when the delay time set in delay circuit 601 elapses, and sets the output signal of D flip-flop 221 (DFF1) to H when set to L.

The switching between “source mode” and “sink mode” is controlled by the output signals LDOCNT1 and LDOCNT2 from DAC value control apparatus 600. The input signal MARK input to DAC value control apparatus 600 outputs L just for a period of two clock signal cycles when the register value of DD1 switches from high to low, and is fixed to L at all other times. When MARK=H, LDOCNT1=LDOCNT2=L, the mode changes to “source mode”; and when MARK=L, SRCNT switches from H to L, and the mode changes from “source mode” to “sink mode.”

In addition, when SRCNT changes from L to H, source mode is restored. If conditions exists where “source mode” and “sink mode” overlap, a through current flows, so that, by changing the outputs of AND gate circuit 605 (AND1) and OR gate circuit 603 (OR2) to L, the mode enters open mode when SRCNT switches by delay circuit 601. That is, the time constant of delay circuit 601 becomes dead time.

In “source mode”, the settings are such that DD2>LDO2, and this needs to be DD2 LDO2 when the mode is switched to “sink mode.” Thus, the output of OR gate circuit 604 (OR3) is set to L and the output of DFF1 is set to H from the time the input signal SCRNT switches from H to L to the delay time, thereby maximizing the value of LDO2.

In “source mode”, DD2 switches after a delay of just two CLKs after the register value change of DD1 by DFF2 and DFF3, but through current occurs in sink MOS transistor M5 since DD2>LDO2 between the first and second CLKs. In “sink mode”, the output of D flip-flop 222 (DFF2) is set to DD2 by selector 211 (SEL1), thereby switching DD2 one CLK after the register value change.

Next, the output voltage switching method will be described.

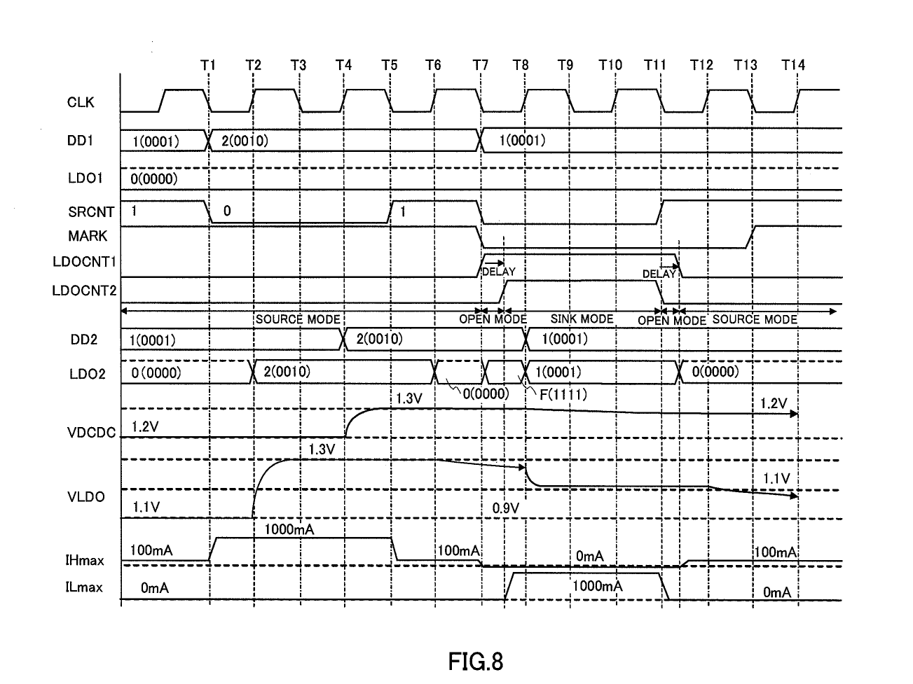

FIG. 8 is a timing chart of output voltage switching that shows the operations of power supply apparatus 500. The numerical values in parentheses for DD1, DD2, LDO1, and LDO2 of FIG. 8 indicate the 4-bit values of the respective data.

In FIG. 8, the operations until time T6 is the operations performed when the voltage is switched from 1.1V to 1.3V, and is the same operations as described by the timing chart in FIG. 5.

The input signal MARK input to DAC value control apparatus 600 is a control signal of “sink mode” when switching for decreasing the output voltage is performed, and switches from H to L when the register value of DD1 switches from high to low. For example, as shown by DD1 in FIG. 8, when DD1 switches from “2” to “1,” the register value of DD1 changes from high to low in terms of size, resulting in input of MARK.

At time T7, MARK switches from H to L. Immediately after that, the mode transitions from “source mode” to open mode and maintains that status until after the delay time. Delay circuit 601 is provided on the output side of OR gate circuit 203 (OR1), and the output of OR circuit 203 (OR1) is delivered to the input of either AND gate circuit 605 (AND1) or NOR gate circuit 607 (NOR2) after a delay of just the delay time indicated in FIG. 8, thereby preventing both output transistor M1 and sink MOS transistor M5 from turning on and causing through current. As shown by LDOCNT1 and LDOCNT2 in FIG. 8, before sink MOS transistor M5 is turned on, both output transistor M1 and sink MOS transistor M5 are turned off and subsequently sink MOS transistor M5 is turned on. In addition, in open mode where the mode transitions from “sink mode” to “source mode”, sink MOS transistor M5 is turned off and output transistor M1 is turned on. During this period, only (path 3) of switching regulator 400 is valid. When SRCNT changes from H to L at time T7, D flip-flop 221 (DDF1) is set and DAC value LDO2 is set to the maximum value. In addition, switch SW6 turns on and the FB resistor of resistor R8 is short-circuited, thereby shifting the feedback voltage value higher.

After the delay time following time T7, the mode transitions to “sink mode” and the set signal of D flip-flop 221 (DFF1) is cleared. At this time, (path 3) of switching regulator 400 and (path 4) of series regulator 700 are valid.

After “sink mode” at time T8, the first CLK edge is introduced. The DAC values of regulators 700 and 400 switch from 2 to 1 for DD2 and from 3 to 1 for LDO2, but because switching regulator 400 is not provided with a sink capacity, output voltage is subjected to feedback control via (path 4) of series regulator 700.

At time T11, SRCNT switches from L to H and the mode transitions from “sink mode” to open mode.

### After the delay time, the mode is restored from open mode to “source mode”, (path 1) becomes valid, and the operation status is returned to normal for series regulator 700.

As described by the timing chart in FIG. 8, when power supply apparatus 500 of the present embodiment switches the output voltage from a 1.3V heavy load state (that is, when switching regulator 400 operates) to 1.2V, series regulator 700 that transitioned to a mode having a sink capacity responds and, by the high-speed responsiveness, pulls down the output voltage to a voltage slightly higher than 1.2V without producing undershoot. Next, sink mode of series regulator 700 is cleared and the output target voltage is changed back to 1.1V. When the output voltage reduces to 1.2V due to the load current, switching regulator 400 starts operation and the main output changes back to the highly efficient switching regulator 400. This series of operations enables quick voltage switching without overshoot.

Thus, according to the present embodiment, series regulator 700 further is comprised of sink MOS transistor M5 provided with a sink capacity that forcibly drops output voltage, and current limit circuit 710 that controls the current limit value of sink MOS transistor M5, and DAC value control apparatus 600 is comprised of elements such as a gate circuit and latch circuit that appropriately control output transistor M1, sink MOS transistor M5, and current limit circuit 710 in a transient state where output voltage decreases, thereby enabling discharge for just a predetermined period of time according to the sink capacity and thorough prevention of undershoot when the output voltage of switching regulator 400 is switched. Thus, the problems of prior art that were difficult to resolve such as system reset due to overshoot can now be resolved. In addition, a stabilizing effect on the feedback of the overall system that combines the power supply apparatus with a CPU that receives power supply from the power supply apparatus can be expected.

The above description is an illustration of a preferred embodiment of the present invention, and this does not limit the scope of the invention.

For example, although with the above-described embodiments, as a means of controlling the output target voltage of the series regulator and switching regulator, DAC is used which controls the output voltage to the target output voltage, the same effect can be achieved using an output target voltage control method other than DAC.

In addition, the types and polarity of the transistors including output transistor M1 and sink MOS transistor M5 are not limited to those in the above-described embodiments.

Further, although the above-described embodiments are examples of application to a power supply apparatus, any circuit configuration is acceptable as long as the circuit where a step-down switching regulator and series regulator are connected in parallel. Additionally, the apparatus may be a DC-DC converter or electronic device provided with the above-described power supply apparatus.

In addition, although the above-described embodiments use the terms “power supply apparatus” and “power supply method”, these terms are used for the sake of convenience and of course may be referred to as, for example, “power source supply apparatus”, “switching regulator”, or “power source control apparatus” as well.

Furthermore, the types, quantities, and connection method of each circuit section, such as the switch element, comparator, or amp, constituting the above-described power supply apparatus are not limited to the above-described embodiments.

Thus, according to the present invention, the voltage switching speed is enhanced without producing overshoot when the setting of the output voltage is increased or without undershoot when the setting of the output voltage is decreased. This prevents device breakage caused by overshoot/undershoot in a CPU chip with low withstand voltage, thereby stabilizing the feedback loop of the overall system.

Thus, the power supply apparatus and power supply method of the present invention are useful for a power supply for a CPU that controls the power supply voltage to decrease power supply consumption, and for a power supply apparatus of an electronic device where the current consumption fluctuates substantially. In addition, the power supply apparatus and power supply method can be broadly applied to power supply circuits for electronic devices such as CPUs and to power supply apparatuses of electronic devices other than a mobile telephone as well.

What is claimed is:

1. A power supply apparatus comprising:
a series regulator that generates and outputs output voltage in accordance with an output target voltage;
a switching regulator that generates and outputs output voltage in accordance with an output target voltage; and
a control apparatus that switches between the series regulator and the switching regulator according to the settings of the output target voltages, wherein:
the output of the series regulator and the output of the switching regulator are connected; and
the control apparatus, when in a stationary state, sets the output target voltage of the series regulator less than or equal to the output target voltage of the switching regulator and, when the output voltage is changed, sets the output target voltage of the series regulator as the output target voltage of the power supply apparatus for just a predetermined period of time.

2. A power supply apparatus comprising:
a series regulator that controls output target voltage according to output of a first DAC;
a switching regulator that controls output target voltage according to output of a second DAC; and
a control apparatus that inputs data to the first DAC and the second DAC, wherein:
the output of the series regulator and the output of the switching regulator are connected; and
the control apparatus, when in a stationary state, sets the output target voltage of the series regulator equal to or less than the output target voltage of the switching regulator and, when the output voltage is changed, sets the output target voltage of the series regulator as the output target voltage of the power supply apparatus for just a predetermined period of time.

3. The power supply apparatus according to claim 1, wherein the control apparatus, when in a transient state where the output voltage is increased, sets the output target voltage of the switching regulator to the output target voltage of the series regulator for just a predetermined period of time, and operates the series regulator.

4. The power supply apparatus according to claim 1, wherein the control apparatus, when in a transient state where the output voltage is increased, sets the output target voltage of the switching regulator to the output target voltage of the series regulator for just a predetermined period of time to operate the series regulator, then activates the switching regulator using the output target voltage of the switching regulator, and subsequently changes the output target voltage of the series regulator back to the output target voltage of the series regulator.

5. The power supply apparatus according to claim 2, wherein: the control apparatus comprises:
a first register that outputs data corresponding to the output target voltage of the series regulator in the stationary state;
a second register that outputs data corresponding to the output target voltage of the power supply apparatus;
a selection circuit that, when in a stationary state, selects the output of the first register 1 and, when in a transient state where the output voltage changes, selects the output of the second register, and outputs the output to the first DAC; and
a latch circuit that inputs the output of the second register and, after a predetermined delay time, inputs the output to the second DAC.

6. The power supply apparatus according to claim 5, wherein:
the control apparatus has a clock terminal that receives a clock signal; and
the latch circuit responds to the clock signals, and holds and inputs the output of the register 2 to the second DAC.

7. A power supply apparatus according to claim 1, further comprising a discharge circuit that discharges the output of the power supply apparatus, wherein the control apparatus, when in a transient state where the output voltage is decreased, makes the discharge circuit valid for just a predetermined period of time.

8. The power supply apparatus according to claim 7, wherein:
the discharge circuit has a control transistor that discharges the output; and
the control apparatus controls the control transistor so that the output voltage changes to the output target voltage.

9. The power supply apparatus according to claim 7, wherein the series regulator comprises the discharge circuit.

10. The power supply apparatus according to claim 1, wherein the series regulator comprises a current limit circuit that limits the output current, and increases the current limit value of the series regulator for just a predetermined period of time when in a transient state where the output voltage is changed.

11. A power supply method for switching between a series regulator and switching regulator that share an output terminal in accordance with usage conditions and supplying power, wherein:
when in a stationary state, output target voltage of the series regulator is set equal to or less than output target voltage of the switching regulator; and
when the output voltage is changed, the output target voltage of the switching regulator is set to the output target voltage of the series regulator for just a predetermined period of time so that power is supplied by the series regulator, even if power of the output voltage is to be supplied by the switching regulator.
